(19) United States
(12) Patent Application Publication
(10) Pub. No.: US 2009/0112929 A1
(43) Pub. Date: Apr. 30, 2009

(54) Digital Registry for Funeral Services

(76) Inventor: Jean Regan, Palos Heights, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/928,451

(22) Filed: Oct. 30, 2007

(51) Int. Cl. G06F 17/30; G06F 3/048

(52) U.S. Cl. 707/104.1; 715/780; 707/E17.044

(57) ABSTRACT

An electronic guest book for funeral services is provided. One or more funeral services can be configured. During the service, a computer permits entry of guest information, such as name, address and comment. Subsequently, the guest information can be used to automate the generation of print materials, such as custom printed labels or envelopes for thank you cards or the like, or a custom printed guest book.

### TECHNICAL FIELD

The present invention relates generally to funeral services, and more particularly, to a digital registry for use in connection with funeral services.

### BACKGROUND OF THE INVENTION

Traditionally, when attending a wake or memorial service, guests and family members are presented with an opportunity to make handwritten entries into a visitation book. Typically these entries include names, addresses and comments. Once a funeral service is concluded, families can use these visitation logs for the purpose of creating thank you notes, which are mailed to those who signed the registry.

### SUMMARY OF THE INVENTION

In accordance with one form of the invention, a method for recording guest information at a funeral service is provided. The method includes the step of providing a computer at the funeral service, which may include a visitation or memorial service, preferably at a location readily accessible to guests. Guest information is received at the computer, such as via entry using a keyboard and video display. The information received is transmitted to a remote server, and stored by the server. The guest information may include each guest's name, address, and a comment. The guest records can be transmitted to the remote server immediately upon entry of each record.

In some embodiments, the method may also include the step of generating one or more print items, using the guest information. A set of guest records containing guest information can be retrieved, such as through query from a database. Information from the guest records can then be printed directly onto print materials such as envelopes, labels or an electronic address book. In some embodiments, the electronic guest book may be a subscription service. To that end, the method may include a step of verifying that the computer is associated with a funeral service provider having a valid subscription prior to the step of receiving guest information at the computer.

In accordance with another aspect of the invention, a system is provided for implementing an electronic guest book for a funeral service. The system includes a server, accessible via a computer network. The server includes a database for storing information received by the computer. The system also includes a subscriber portal, implemented by the server. The subscriber portal may include an authentication module, towards ensuring that a subscriber is authorized for access. The subscriber portal includes one or more fields which enable the creation and modification of service database records corresponding to the funeral service. The system also includes a guest book portal, which is initiated via the subscriber portal. The guest book portal includes fields that permit entry of guest information, and transmission of that information to the server for storage within the database. Guest information may include items such as guest name, address and comment. A print production portal includes a display permitting selection of a database record, and a print layout and production module, which received information from the database record for generating a custom print product. Finally, a printer receives information from the print layout and production module for generating custom print materials. The print materials may include items such as labels, envelopes, or an electronic guest book. A remote user portal can also be provided, which may permit remote access to information such as service dates, times and locations, and/or entry of comments or other information concerning the remote user.

### BRIEF DESCRIPTION OF THE DRAWINGS

FIG. 1 is a diagrammatic block diagram of a system for implementing an electronic guest book for funeral services.

FIG. 2 is a subscriber login display.

FIG. 3 is a subscriber service list display.

FIG. 4 is a service configuration display.

FIG. 5 is an electronic guest book display.

FIG. 6 is a display of subscribing funeral service providers.

FIG. 7 is a display permitting selection of a print product for production.

FIG. 8 is a print production and layout display.

FIG. 9 is a diagrammatic block diagram of another embodiment of a system for implementing an electronic guest book for funeral services.

FIG. 10 is a diagrammatic block diagram of yet another embodiment of a system for implementing an electronic guest book for funeral services.

FIG. 11 is a diagrammatic block diagram of program modules for implementing an electronic guest book and print production system for funeral services.

### DETAILED DESCRIPTION

While this invention is susceptible of embodiment in many different forms, there are shown in the drawings and will herein be described in detail, certain specific embodiments with the understanding that the present disclosure should be considered as an exemplification of the principles of the invention and is not intended to limit the invention to the embodiments so illustrated or described.

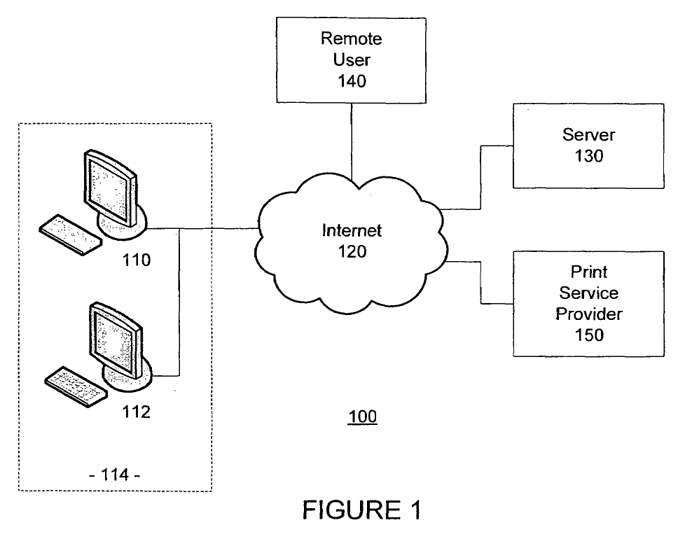

Referring initially to FIG. 1, system 100 is provided for implementing a digital registry which enables guests or family members attending a wake or memorial service at a funeral home or place of worship to utilize a computer-based registry service for recording names, addresses and/or personal comments. Office computer terminal 10 and guest computer terminal 112 are provided at the funeral home location 114 of the wake or memorial service. Typically, computer terminals 110 and 112 include a data entry device, such as a keyboard, and a display, such as an LCD monitor. Office computer 110 is typically located in an office portion of funeral home 114, while guest computer 112 would be provided in a public area, accessible to guests attending a service. While office computer 110 and guest computer 112 are illustrated in the embodiment of FIG. 1 as separate devices, it is understood that the functionality of each could be readily implemented on a single computer, or using more than two computers. Also, while office computer 110 and guest computer 112 are both illustrated as residing within funeral home 114, it is understood that either or both computers could readily be located anywhere, and particularly any location at which access to Internet 120 can be provided.

Computer terminals 10 and 112 communicate via Internet 120 with server 130. In some embodiments, server 130 provides a web portal application that is accessed via web browser software on computer terminals 110 and 112. However, it is understood that such a web site application could readily be implemented as a local application on computer terminals 110 and/or 112, which could communicate with server 130 for the remote storage and retrieval of data. Server 130 further comprises a database, which can be used to store subscriber, funeral service and/or guest information that is received via the web portal, as described further hereinbelow. While server 130 is illustrated diagrammatically as a single device in system 100, it is understood that the features implemented by server 130 could readily be distributed amongst a plurality of computing devices without departing from the scope of the invention.

Remote computer terminal 140 is also capable of accessing server 130. In some embodiments, remote computer terminal 140 may be a home computer that is used to access server 130 by friends, relatives or other acquaintances of individuals for whom services are being held. Such individuals can access server 130 for purposes such as the lookup of information concerning funeral services, or to leave messages paying their respects to the family of the deceased, particularly if the remote user is unable to attend the service.

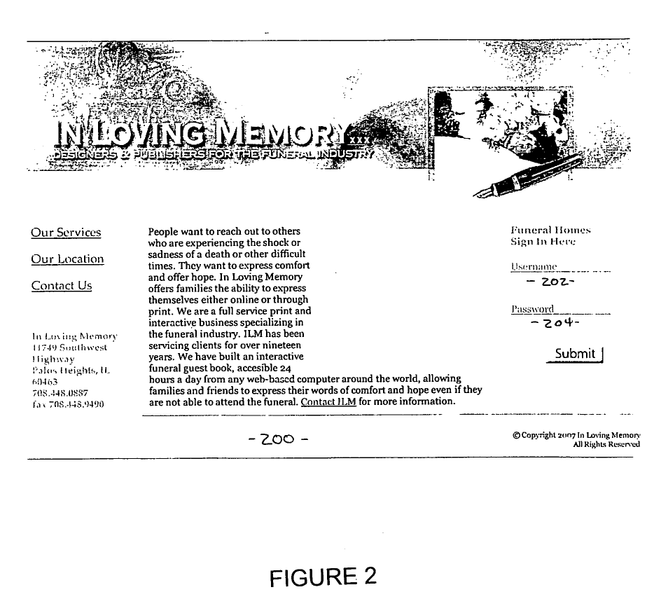

In operation, computer terminal 110 is operated by a funeral service provider, to access server 130 via a web browser. The user of computer terminal 110 is presented with a logon screen, such as display 200, illustrated in FIG. 2. Username field 202 and password field 204 provide a mechanism for identification and authentication of the user of computer terminal 110. In accordance with an exemplary embodiment of the invention, the funeral service provider subscribes to a service implemented by, inter alia, server 130. Examples of such subscription programs may be a subscription based upon a periodic fee, such as a monthly fee, for access to an account implemented on server 130. In another exemplary embodiment, a transactional, lump sum subscription fee could be charged for each funeral service that is set up on server 130. Other embodiments may include a combination of periodic and transactional fees.

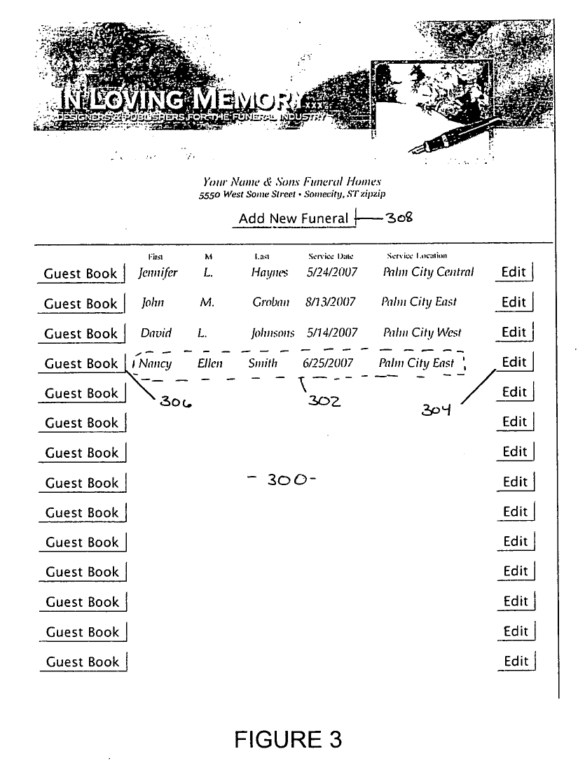

FIG. 3 illustrates a display that can be provided to computer terminal 110 by server 130 once a service provider is authenticated with server 130. Region 300 provides a display which includes a list of services that have been previously configured by the service provider. For example, region 302 lists identifying information concerning one service that has been configured. Additional information for the service can be entered and/or edited by selecting button 304. Alternatively, during the service, an electronic guest book function can be initiated by selected button 306. A new funeral can be configured by selecting button 308.

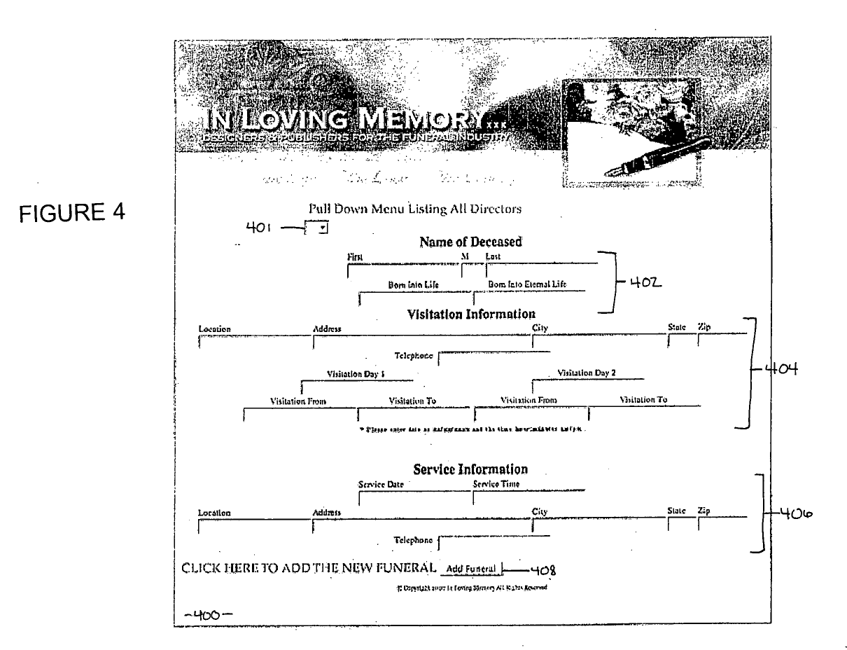

Upon selection of button 308, a new funeral configuration screen is presented on computer terminal 110, such as the display 400 of FIG. 4. Display 400 permits the entry of information corresponding to a particular funeral service. Pull down menu 401 permits the identification of a particular funeral service director, from amongst a listing of directors affiliated with the funeral home corresponding to the current user account, who is responsible for the service. Fields 402 permit entry of identifying information for the decedent. Fields 404 permit entry of information describing the time and location of a visitation. Fields 406 permit entry of information describing the time and location of the funeral service. Once the desired information has been entered, button 408 initiates the transmission of information entered into display 400 to server 130, for creation and/or editing of a database record corresponding to the service. The newly-configured service is added to the service list in subsequent iterations of display 300. After a service appears on the service list of display 300, selection of a corresponding “EDIT” button, such as button 304, permits a user to return to display 400 (FIG. 4) to change information in the various fields, thereby modifying a database record in server 130 corresponding to the selected service.

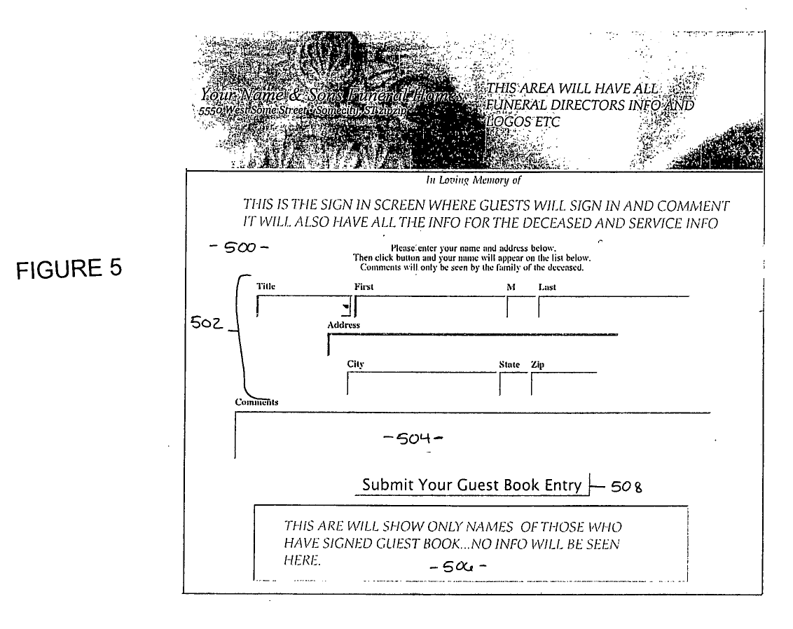

Once a service has been set up and appears on the service list of display 300, an associated Guest Book button, such as button 306, can be selected to initiate display 500 permitting operation of an electronic guest book feature, which is illustrated in FIG. 5. In some embodiments, display 500 will be accessed as described above, using guest computer terminal 112, which is located in a public area during a funeral or other memorial service. Display 500 is adapted for use by guests during such a service. Rather than recording desired information by hand into a paper visitor book, display 500 permits guests to enter any desired information directly into computer terminal 112. Fields 502 permit a guest to enter their name and address. Because the information is entered digitally, such as via a keyboard, problems with the legibility of guest information, which often plagues handwritten guest books, are eliminated. Field 504 provides an area for a guest to express their sentiments concerning the event.

The user can be advised in message area 506 that information other than the guest name will not be publicly displayed after submission. The present system's recordation of a guest's entered information without displaying it publicly at the event provides a substantial distinction compared to conventional, handwritten guest books which are readily available to any guests in attendance. The additional level of privacy afforded by the present system may encourage guests to provide complete contact information when they might otherwise have privacy concerns, thereby capturing guest information that can be utilized more usefully by the family of the decedent in subsequent communications, as described further below. Additionally, maintaining the privacy of guest comments entered into field 504 may encourage some guests to provide more meaningful, heart-felt sentiments.

Once a guest has completed entering information in display 500, Submit button 508 can be selected. When button 508 is selected, the information entered on display 500 is transmitted to server 130 via Internet 120, and stored thereon. By providing for remote storage of electronic guest book data for a number of different funeral service providers, the data can be archived and maintained using sophisticated data storage services that might otherwise be impracticable for implementation by a single funeral service provider. After one or more guests has submitted information, subsequent transmissions of display 500 from server 130 to guest computer terminal 112 may include the names of individuals completing guest book entries within region 506.

By capturing guest book information digitally, and storing that information on server 130, the information can subsequently be used advantageously by individuals sponsoring the service. For example, in many cases, families wish to send out thank you notes to guests attending a funeral service. Traditionally, the paper guest book is used to obtain the names and addresses of guests. Entries in such handwritten logs are frequently very difficult to read, resulting in errors in guest names or addresses. Even for entries having legible handwriting, the process of manually copying names and addresses onto envelopes and cards can be cumbersome and time consuming.

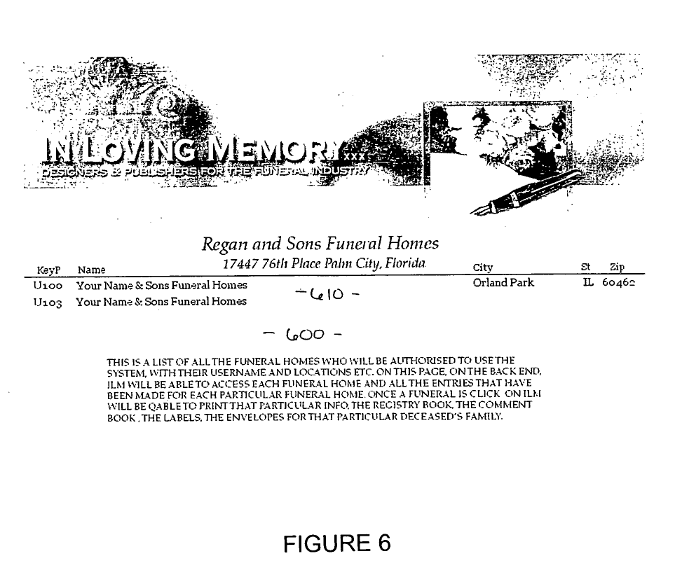

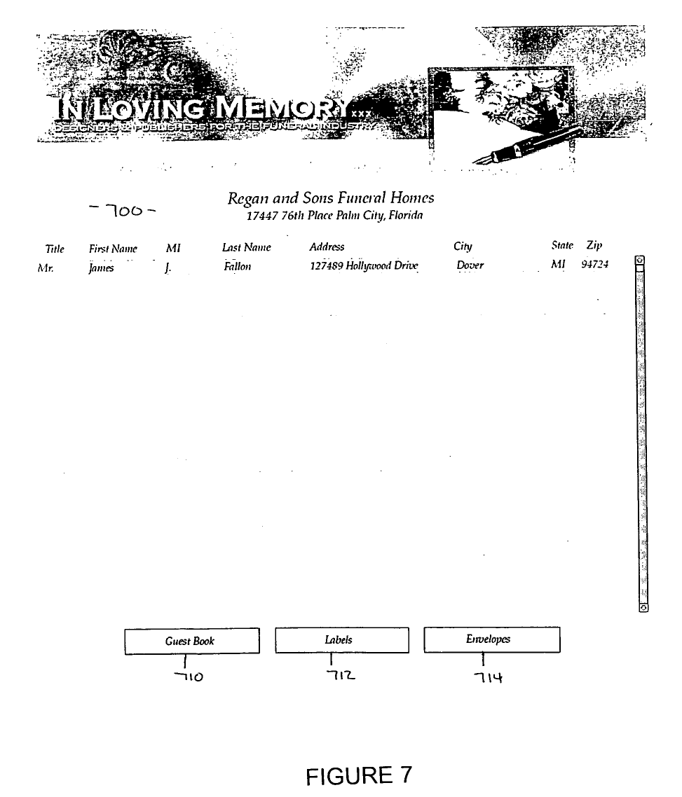

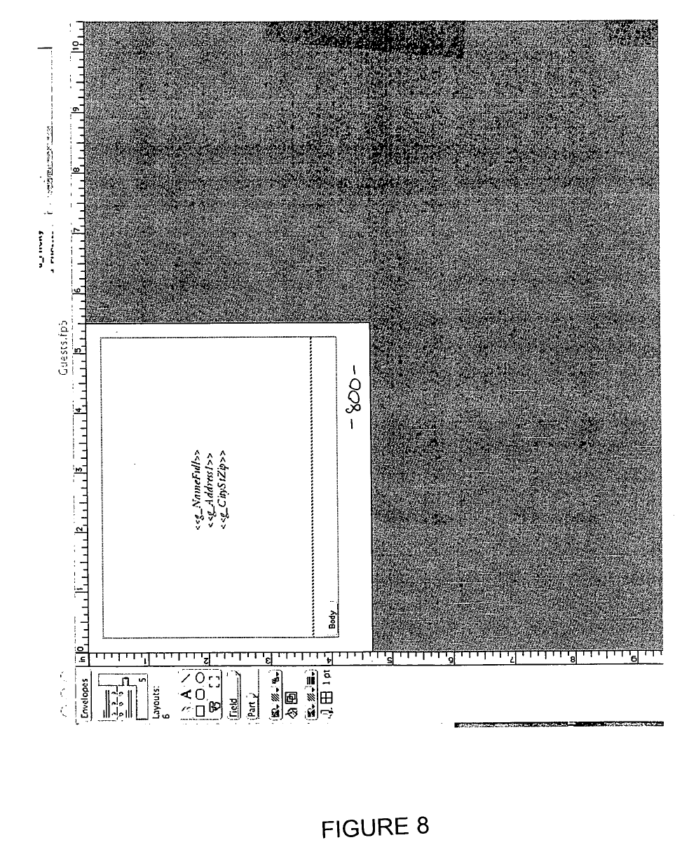

However, using system 100, data entered by guests can be used directly to generate customized printed materials, such as envelopes, labels and guest books. For example, in system 100, print service provider 150 accesses a web portal implemented by server 130 to access display 600 (FIG. 6) which provides a list of funeral homes having accounts on server 130 in display area 610. By selecting a funeral home from area 610, a user is able to navigate through a listing of configured funeral services to select a desired guest list. Upon selection of a service, display 700 (FIG. 7) is provided, listing the guests attending the selected funeral service. Button 710 can be selected to initiate the layout and printing of a custom printed guest book. Button 712 can be selected to initiate the printing of labels for each guest, to facilitate the mailing of thank you notes or other correspondence. Button 714 can be selected to initiate the printing of custom envelopes for each guest, which can also be used for mailings of correspondence to guests. If envelope button 714 is selected, display 800 (FIG. 8) is provided, facilitating the layout and formatting of an envelope template.

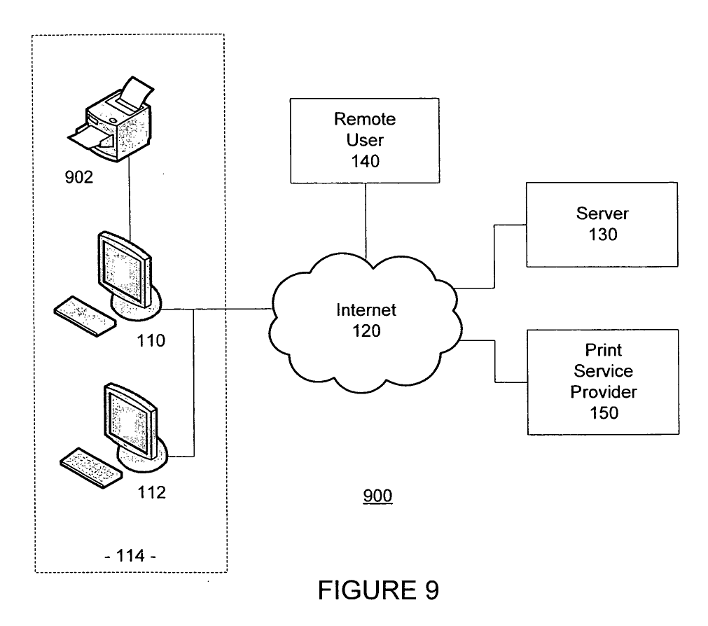

Once guest information and a product are selected, the custom product can be printed. In the embodiment of system 100, print service provider 150 prints the desired product and provides it to funeral home 114 or the end client. System 900 (FIG. 9) illustrates another embodiment, in which funeral home 114 implements printer 902, connected to office computer terminal 110. In the embodiment of system 900, server 130 provides access to print material displays 700 and 800 to funeral home service providers through the funeral home web portal. Customized print product data can be configured as described above in connection with system 100, and transmitted to funeral home computer 110 via Internet 120, to enable printing of the desired products on printer 902, for provision directly to the client by funeral home 114. In yet other embodiments, customized print product data can be transmitted to a client's remote computer via a client web portal, for printing directly by the client.

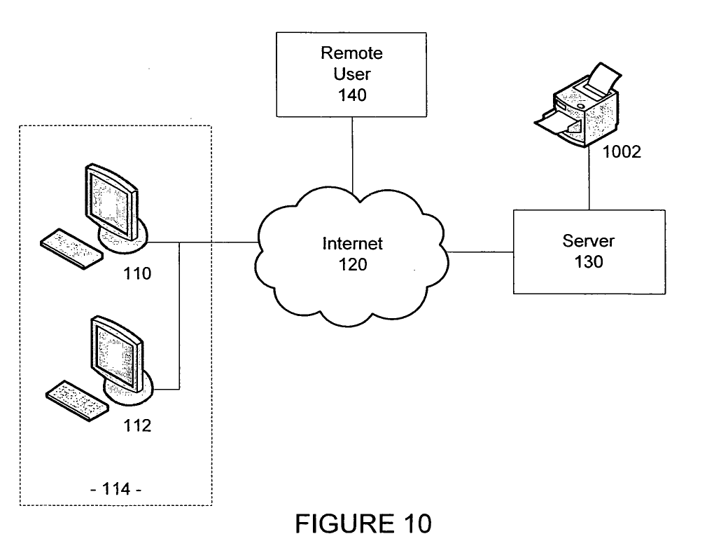

While print service provider 150 is illustrated in system 100 as a separate entity, communicating with server 130 via Internet 120, it is understood that in other embodiments, printing facilities can be implemented locally to server 130. One such embodiment is illustrated in FIG. 10, in which printer 1002 communicates locally with server 130 to enable generation of print materials.

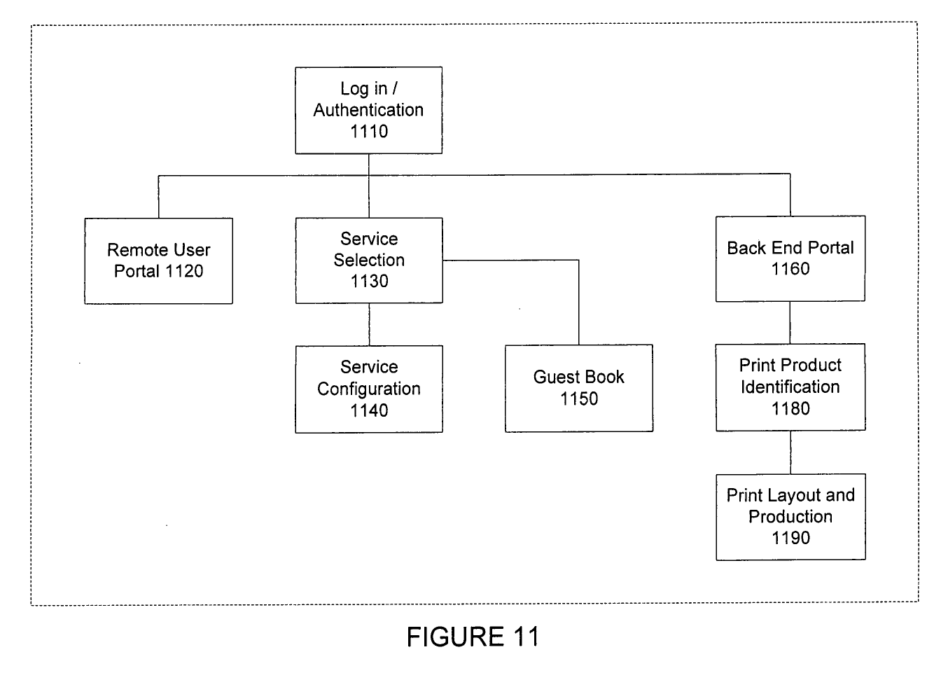

FIG. 11 illustrates an exemplary, diagrammatic block diagram of program modules that can be implemented by, for example, server 130. Log In/Authentication module 1110 provides, inter alia, display 200, through which various types of users can access features of the present system. For remote users, such users of remote user terminal 140, log in module 1110 directs users to remote user portal 1120, through which individuals can retrieve information such as time, date and location information for funeral or memorial services. Users can be directed to remote user portal 1120 based upon a particular Internet address through which the system was accessed, preconfigured for access to remote user portal 1120, or through selection of hyperlinks corresponding to remote user portal 1120. Once accessed, remote user portal 1120 can optionally provide a message board, on which remote users can submit notes or comments.

Funeral home service providers logging into display 200 are subsequently directed to service selection module 1130, which implements display 300. If new service button 308 is selected, or if edit button 304 is selected, the user is directed to service configuration module 1140, which implements display 400. If Guest Book button 306 is selected, guest book module 1150 implements display 500.

Print production users are directed to back end portal 1160, which provides a gateway for access to, amongst other features, print production services. Back end portal 1160 presents display 600, through which a particular funeral home and service can be selected. Print product identification module 1180 provides display 700, enabling selection of a desired type of print material, such as a guest book, labels or envelopes. Finally, print layout and production module 1190 implements layout display 800, through which a selected print product can be further customized and generated.

While the program modules of FIG. 11 can be implemented by an Internet-connected server, such as server 130, in accordance with other aspects of the invention, the modules of FIG. 11 can be readily implemented locally, by a computer located at a funeral home.

The foregoing description and drawings merely explain and illustrate the invention and the invention is not limited thereto, inasmuch as those skilled in the art, having the present disclosure before them will be able to make modifications and variations therein without departing from the scope of the invention.

What is claimed is:

1. A method for recording guest information at a funeral service comprising the steps of:
providing a computer at the funeral service;
receiving guest information at the computer;
transmitting the guest information to a remote server;
storing the guest information by the remote server.

2. The method of claim 1, in which the guest information comprises a plurality of guest records, each guest record comprising a name, address and comment.

3. The method of claim 1, in which:
the step of receiving guest information at the computer comprises the step of receiving a plurality of guest records; and
the step of transmitting the guest information to a remote server comprises the step of transmitting each guest record to a remote server as each record is completed.

4. The method of claim 1, further comprising the steps of:
generating one or more print items, each print item being printed with at least a portion of the guest information.

5. The method of claim 4, in which the step of generating one or more print items comprises the steps of:
retrieving a set of guest records, each guest record comprising a guest name and address, from amongst the guest information;
printing information from each guest record onto one or more envelopes.

6. The method of claim 4, in which the step of generating one or more print items comprises the steps of:
retrieving a set of guest records, each guest record comprising a guest name and address, from amongst the guest information; and
printing information from each guest record onto one or more labels.

7. The method of claim 4, in which the step of generating one or more print items comprises the steps of:
retrieving a set of guest records from amongst the guest information, each guest record comprising a guest name and a comment; and
printing information from the guest records into a guest book.

8. The method of claim 1, further comprising the step of verifying that the computer is associated with a funeral service provider having a valid subscription prior to the step of receiving guest information at the computer.

9. A system for implementing an electronic guest book for a funeral service comprising:
a server, accessible via a computer network, comprising a database for storing information received thereby;
subscriber portal, implemented by the server, comprising one or more fields for entering and modifying a service database record corresponding to the funeral service;
a guest book portal initiated through selection of a portion of a subscriber portal display, the guest book portal comprising one or more fields into which guest information can be entered for transmission to the server and storage within the database; and
a print production portal comprising: a display permitting selection of the database record, and a print layout and production module, which receives information from the database record for generating a custom print product; and
a printer which receives information from the print layout and production module for generating custom print materials.

10. The system of claim 9, in which the guest information comprises a guest name, address and comment.

11. The system of claim 9, in which the print materials comprise one or more labels printed with information from the database record.

12. The system of claim 9, in which the print materials comprise one or more envelopes printed with information from the database record.

13. The system of claim 9, in which the print materials comprise a guest book printed with information from the database record.

14. The system of claim 9, further comprising a remote user portal, accessible via the Internet, which displays service information relating to the funeral service.

15. The system of claim 14, in which the service information comprises a date, time and location of the service.

16. The system of claim 14, in which the remote user portal further comprises a message board permitting entry of information corresponding to the identity of the remote user.

17. The system of claim 9, in which the subscriber portal further comprises an authentication module.

18. The system of claim 9, in which the server comprises a web server; the system further comprising a guest computer terminal configured for communication with the web server to access the guest book portal via the computer network.

19. An electronic guest book for a funeral service implemented on one or more computers, comprising:
a database for storing information;
configuration module comprising one or more fields for entering and modifying a service database record corresponding to a funeral service;
a guest book module initiated through selection of a portion of a configuration module display, the guest book module comprising one or more fields into which guest information can be entered for storage within the database; and
a print production modules comprising a print layout and production application which receives at least a portion of the guest information from the database; and
a printer which receives information from the print layout and production module for generating print materials containing at least a portion of the guest information from the database.

20. The electronic guest book of claim 19, in which the guest information comprises a guest name, address and comment.
